(19) United States
(12) Patent Application Publication
(10) Pub. No.: US 2004/0197481 A1
(43) Pub. Date: Oct. 7, 2004

(54) Novel low viscosity prepolymers with low diisocyanate monomer content for moisture cure coatings

(76) Inventors: Peter J. Whitman, Glen Mills, PA (US); Daniel B. Pourreau, Exton, PA (US); Michael J. Morgan, Spring City, PA (US); Stephen L. Goldstein, Glen Mills, PA (US)

Correspondence Address: BROOKS KUSHMAN P.C., 1000 TOWN CENTER, TWENTY-SECOND FLOOR, SOUTHFIELD, MI, 48075, US

(21) Appl. No.: 10/405,390

(22) Filed: Apr. 2, 2003

(51) Int. Cl. B05D 3/02; C08G 18/28

(52) U.S. Cl. 427/372.2; 528/73; 528/76; 528/80

(57) ABSTRACT

The present invention provides a urethane prepolymer and method of making said prepolymer useful in forming a moisture curable coating on an object. The prepolymer of the present invention is made by the process comprising reacting a HDI-uretidione with a polyol such that a moisture-curable urethane prepolymer having a viscosity at 25° C. less than about 3000 cP is formed. Moreover, the HDI-uretidione and the polyol are of sufficient amounts that the reaction index is at least about 2. The present invention also provides a method of coating a substrate with the prepolymer of the present invention.

### BACKGROUND OF THE INVENTION

1. Field of the Invention

In at least one aspect, the present invention relates to prepolymers for forming moisture curable coatings, and in particular to prepolymers that have a low diisocyanate monomer content and are useful for forming moisture curable coatings.

2. Background Art

Polyurethane compositions find utility in a variety of applications due to the adjustability of their physical properties by selection of the appropriate building blocks. For example, polyurethanes are used in the furniture industry for make foam that is used for cushioning; for packaging; making gaskets, and for various types of linings. Polyurethane coatings are particularly useful in protecting surfaces. Such surface coatings impart both abrasion and chemical resistance. Moreover, polyurethane coatings are desirable because of their good adhesion properties, flexibility, and fast curability.

Polyurethanes are generally made by the reaction of a diisocyanate with a diol polyol. Polyurethane-forming processes are generally divided into one component systems and two component systems. A typical one component system is a moisture curing system in which a prepolymer reacts with ambient water vapor to chain extend and cure.

Another typical one component system can be produced by the “blocking” of isocyanate groups so that they are temporarily unable to react. This is usually achieved by reaction of the isocyanate with specific hydroxy containing molecules, such as phenols or tertiary alcohols, that are characterized by their comparatively unstable urethane links. The blocked isocyanate, which can be a diisocyanate, a quasi-prepolymer or a prepolymer, can then be handled and processed without concern for further reaction/gelation, since no unreacted isocyanate remains. When processing is complete, heat is applied to break the bonds of the blocking groups, regenerating the isocyanate compound, and allowing the polyurethane to fully cure. Many attempts have been made to lower unblocking temperatures, but commercial systems still often have to be raised to at least 100° C. in order to effect the unblocking reaction.

There are two common types of two component systems—one shot systems and prepolymer systems. In the one shot system, the polyol is first blended with one or more catalysts and various additives such as flame retardants, plasticisers, filler, and the like. This polyol-containing mixture is then reacted with a diisocyanate. In the two component prepolymer method, a polyurethane precursor is made by reacting one equivalent of polyol with up to two equivalents of isocyanate. Typically, prepolymers have molecular weights from about 1000 to about 8000. Polyurethanes are then produced by the reaction of prepolymers with a chain extender such as a polyol or a diamine.

Although both the one component and two component systems work reasonably well in producing polyurethanes, each process typically produces material that is contaminated with diisocyanate monomer, exposure to which may be hazardous to worker's health. Such contamination is undesirable because diisocyanate monomers are volatile organic compounds. Removal of these monomers from these process typically requires expensive processing such a wiped film evaporation. Accordingly, there is a need for an improved polyurethane prepolymer system that contains reduced amounts of diisocyanate monomers.

### SUMMARY OF THE INVENTION

The present invention overcomes the problems encountered in the prior art by providing in one embodiment, a urethane prepolymer blend contains less than about 1% by weight diisocyanate monomer and a viscosity at 25° C. that is less than about 3000 cP. The urethane prepolymer of the present invention is made by reacting the uretidione of hexamethylenediisocyanate (HDI-uretidione) with a polyol wherein the reaction index is at least about 2. The prepolymer formed by the method of the present invention may optionally include one or more components selected from the group consisting of aliphatic diisocyanate adducts, catalysts, flow promoting agents, surfactants, UV stabilizers, fillers, pigments, solvents, and mixtures thereof. The prepolymer compositions of the present invention, are moisture curable into coatings with outstanding gloss, hardness, impact resistance, and environmental/chemical resistance. Moreover, the prepolymer compositions of the present invention allows for relatively thick layers to be applied to a substrate which are free of bubbles caused by outgassing of carbon monoxide.

In another embodiment of the invention, a method for coating a substrate with a urethane coating is provided. In accordance with this method, the prepolymer of the present invention is applied to a substrate and then cured.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

The term “reaction index” as used herein refers to the stoichiometry used in a polyurethane reaction defined as the ratio of the number of isocyanate equivalents (—NCO) to the number of active hydrogen groups (—OH and —NH₂) available for reaction.

In an embodiment of the present invention, an improved urethane prepolymer blend is provided. The prepolymer blend of the invention is made by the process comprising:

providing HDI-uretidione and a polyol, the polyol having two or more hydroxyls; and

reacting the HDI-uretidione with the polyol such that a urethane prepolymer that is moisture-curable and has a viscosity at 25° C. less than about 3000 cps is formed, wherein the HDI-uretidione and the polyol are present in a sufficient amount that the reaction index is at least about 2. More preferably, the HDI- uretidione and the polyol are present in a sufficient amount that the reaction index is at least about 5, and most preferably the HDI-uretidione and the polyol are a sufficient amount that the reaction index is at least about 10. In a preferred embodiment of the present invention, the reaction index is from about 10 to about 20. More preferably, the reaction index in this embodiment is from about 12 to 17; and more preferably the reaction index is about 15. The prepolymer blend of the present invention will contain less than about 1% by weight diisocyanate monomer. More preferably, the prepolymer blend will contain less than about 0.5% by weight diisocyanate monomer; and most preferably, the prepolymer blend will contain less than about 0.2% by weight diisocyanate monomer. Examples of HDI-uretidione, include HD-100 formerly available from Lyondell Chemical located in Newtown Square, Pa.

Suitable polyols to be used in the preparation of the urethane prepolymer include, but are not limited to, polyether polyols, polyester polyols, acrylic polyols, or mixtures thereof. Preferred polyols are liquids containing little (i.e., less than 5%) volatile organic compounds. Particularly preferred polyols, are the polyols disclosed in U.S. Pat. No. 5,475,073, U.S. Pat. No. 5,480,943, U.S. Pat. No. 5,525,693, U.S. Pat. No. 5,571,884, U.S. Pat. No. 5,534,598, and U.S. Pat. No. 6,294,607. These patents are hereby incorporated by reference. These preferred polyols include low-molecular-weight, hydroxy-functional acrylate resins that are derived from an allylic alcohol or a propoxylated allylic alcohol, an acrylate or methacrylate monomer, and optionally, one or more additional ethylenic monomers. Moreover, these resins are uniquely prepared without a chain-transfer agent or reaction solvent. A particular example of such an acrylate resin comprises recurring units of a propoxylated allylic alcohol of the formula CH₂═CR—CH₂—(A)ₙ—OH, a C₁-C₂₀ alkyl or aryl acrylate or methacrylate monomer in which A is an oxypropylene group, and optionally, one or more ethylenic monomers. Suitable ethylenic monomers are selected from the group consisting of vinyl aromatic monomers, unsaturated nitrites, vinyl esters, vinyl ethers, vinyl halides, vinylidene halides, unsaturated anhydrides, unsaturated dicarboxylic acids, acrylic and methacrylic acids, acrylamide and methacrylamide, and conjugated dienes. R is selected from the group consisting of hydrogen and C₁-C₅ alkyl and n is the average number of oxypropylene groups in the propoxylated allylic alcohol and has a value less than or equal to 2. The acrylate resin has a hydroxyl number within the range of about 20 to about 500 mg KOH/g, and a number average molecular weight within the range of about 500 to about 10,000. More preferably the acrylate or methacrylate monomer is a C₁-C₁₀ alkyl acrylate or methacrylate. The acrylate resin preferably comprises from about 0.1 to about 50 wt. % of an ethylenic monomer selected from the group consisting of styrene, acrylonitrile, and mixtures thereof. More preferably the acrylate resin comprises from about 5 to about 60 wt. % of the propoxylated allylic alcohol, from about 40 to about 95 wt. % of the acrylate or methacrylate monomer, and from about 5 to about 10 wt. % of an ethylenic monomer selected from the group consisting of styrene, acrylonitrile, and mixtures thereof. In a further refinement the acrylate resin more preferably has a hydroxyl number within the range of about 50 to about 450 mg KOH/g; and most preferably a hydroxyl number within the range of about 100 to about 250 mg KOH/g. Also, in this variation the number average molecular weight is within the range of about 1000 to about 3000. Examples of polyols include Joncryl 500™ a high solids polyol system commercially available from S. C. Johnson located in Racine, Wis.; Macrynal VSM 2800 available from Solutia, Inc.; and the Acryflow™ line of polyols (e.g. Acryflow P120 and Acryflow P130) available from Lyondell Chemical. The Acryflow™ polyols are liquid acrylic polyols that do not contain volatile organic compounds (“VOC”.)

Optionally, the prepolymer formed by the method of the present invention is combined with one or more components selected from the group consisting of aliphatic diisocyanate adducts, catalysts, cross-linking agents, chain lengthening agents, flow promoting agents, surfactants, UV stabilizers, fillers, pigments, solvents, and mixtures thereof. Preferred aliphatic diisocyanate adducts to be combined with the prepolymer formed by the method of the invention include, for example, an isocyanate trimer, an HDI biuret, HDI allophanates, or mixtures thereof. Examples of HDI trimers include Luxate HT-2000 commercially available from Lyondell Chemical. Examples of HDI biurets include Luxate HB-9000 commercially available from Lyondell Chemical. Suitable surfactants include, but are not limited to, silicones and fluorocarbon surfactants, such as Fluorad FC-430 commercially available from 3M and Lodyne products commercially available from Ciba-Geigy.

Catalysts, include for example tertiary amines (e.g. triethylenediamine, triethylamine, N-methylmorpholine, N-ethylmorpholine, N,N,N′N′-tetramethylbutanediamine) and organic tin compounds (e.g. stannous octoate and dibutyl tin dilaurate). An example of a tin catalyst is Dabco T-12 (dibutyltin dilaurate) available from Air Products and Chemicals, Inc. Typically, cross-linking agents and chain lengthening agents are low molecular weight compounds that have active hydrogen (—OH, —NH₂). Moreover, these agents preferably have a functionality of 3 or more (triols, tetrols.) Examples of cross-linking or chain lengthening agents are diethanolamine, triethanolamine, glycerin, and the like.

Flame retardants include, for example, halogen-containing compounds, antimony oxides, or phosphorus compounds. Suitable flame retardants include, but are not limited to aluminum trihydrate, antimony oxide (Sb₂O₃), and decabromobiphenyl oxide (“decabrome”). Other examples of flame retardants are tris(chloroethyl) phosphate, tris(2-chloroethyl) phosphate, tris(dichloropropyl) phosphate, chlorinated paraffines, tris(chloropropyl) phosphate, phosphorus-containing polyols, and brominated polyols.

Suitable UV stabilizers include, but are not limited to hindered amine light stabilizers (“HALS”). Examples of HALS include: Chimassorb 944, Chimassorb 994, Chimassorb 905, Tinuvin 770, Tinuvin 992, Tinuvin 622, Tinuvin 144, and Spinuvex A36 available from Geigy; and Cyasorb UV 3346 and Cyasorb UV 944 commercially available American Cyanamide. Particularly preferred UV stabilizers are Cytec UV 3346 and Chemasorb 944 (poly[N,N-bis(2,2,6,6-tetramethyl-4-piperidinyl)-1,6-hexanediamine-co-2,4-dichloro-6-morpholino- 1,3,5-triazine.)

Suitable examples of fillers include, but are not limited to, calcium carbonate, titanium dioxide, talc, zirconium dioxide, zinc oxide, calcium silicate, aluminum silicate, calcium sulfate, alumina trihydrate, glass fibers, carbon fibers, and mixtures thereof.

The HDI-uretedione is reacted with the polyol by methods known to one skilled in the art of polyurethane chemistry. Such methods of reaction include, but are not limited to: 1) charging a reaction vessel with the HDI-uretidione and then slowly adding the polyol to the reaction vessel and 2) rapidly combining the HDI-uretidione and the polyol together in a reaction vessel (i.e., pouring one component into the other.) The preferred method of reaction is by charging a reaction vessel with the HDI-uretidione and then slowly adding the polyol to the reaction vessel

In another embodiment of the present invention, a method of making a urethane coating on a substrate is provided. The method of this embodiment comprises:

coating a substrate with the urethane prepolymer of the present invention as set forth above to form a coated substrate; and

allowing the coated substrate to moisture cure in ambient air.

Moreover, the prepolymer used in the method of this embodiment optionally includes (as set forth above) one or more components selected from the group consisting of aliphatic diisocyanate adducts, catalysts, cross-linking agents, chain lengthening agents, flow promoting agents, surfactants, UV stabilizers, fillers, pigments, solvents, and mixtures thereof.

The following examples illustrate the various embodiments of the present invention. Those skilled in the art will recognize many variations that are within the spirit of the present invention and scope of the claims. Each of the following examples were prepared without adding any additional solvents not present in the HDI-uretidione or the polyol.

### EXAMPLE 1

In a 200 ml round bottom flask were placed 15.62 g (0.0283 eq.) of Macrynal VSM 2800 acrylic and 55.00 g (0.2984 eq.) of HD-100 and stirred for 10 min. Three drops of T-9 tin catalyst (stannous octoate) was added and stirred for 7 min. The reaction temperature had warmed to 31° C. The flask was then immersed in an oil bath set at 96°±1° and heated for 3.3 hr. (the reaction temperature was 85±1°) followed by addition of 28.49 g (0.1492 eq.) of HB-9000. The reaction mixture was stirred at the same temperature for 1.3 hr. The oil bath was then removed, and the reaction product decanted into a bottle. The resulting composition had the following properties: NCO/OH=15.84; % NCO (theoretical)=17.78; % NCO (experimental)=17.03%; viscosity=1,799 cP.

A prepolymer formulation (“Formulation 1”) is formed by 15.0 g of the prepolymer made above with 5.0 g ethyl 3-ethoxypropionate (“EEP”), 0.5 g of 10% Fluorad FC-430, and 0.1 g of T-12.

### EXAMPLE 2

The procedure of example 1 was followed except that 10.33 g (0.0322 eq.) of Joncryl 500 acrylic instead of Macrynal and 62.96 g (0.3416 eq) of HD-100 were initially utilized. Subsequently, 32.63 g (0.1709 eq.) of HB-9000 were added and the reaction mixture heated as set forth above for example 1 hours to yield a composition having the following properties: NCO/OH=15.91; % NCO (theoretical)=19.06; % NCO (experimental)=18.83%; viscosity=787.4 cP.

### EXAMPLE 3

The procedure of example 1 was followed except that 12.94 g (0.0333 eq.) of Acryflow P130 acrylic (commercially available from Lyondell) instead of Macrynal and 65.05 g (0.3530 eq) of HD-100 were initially utilized. Subsequently, 34.49 g (0.1765 eq.) of HT-2000 were added. Furthermore, the resulting reaction mixture is heated for 2 hours to yield a composition having the following properties:: NCO/OH=15.90; % NCO (theoretical)=18.54; % NCO (experimental)=18.16%; viscosity=1,064 cP.

### EXAMPLE 4

The procedure of example 1 was followed except that 14.00 g (0.0332 eq.) of Acryflow P120 acrylic (commercially available from Lyondell) instead of Macrynal and 65.05 g (0.3530 eq) of HD-100 were initially utilized. Subsequently, 34.49 g (0.1765 eq.) of HT-2000 were added. The resulting reaction mixture was heated for 2 hours to yield a composition having the following properties: NCO/OH=15.95; % NCO (theoretical)=18.37; % NCO (experimental)=17.68%; viscosity=1,984 cP.

A prepolymer formulation (“Formulation 4”) is formed by 15.0 g of the prepolymer made above with 5.0 g EEP, 0.5 g of 10% Fluorad FC-430, and 0.1 g of T-12.

### EXAMPLE 5

The procedure of example 1 was followed except that 15.80 g (0.0286 eq.) of Joncryl 500 acrylic of Macrynal and 55.66 g (0.3020 eq) of HD-100 were initially utilized. Subsequently, 29.50 g (0.1510 eq.) of HT-2000 were added. The resulting reaction mixture was heated for 3.5 hr. to yield a composition having the following properties: NCO/OH=15.85; % NCO (theoretical)=17.66; % NCO (experimental)=17.22%; viscosity=1,461 cP.

A prepolymer formulation (“Formulation 1”) is formed by 15.0 g of the prepolymer made above with 5.0 g EEP, 0.5 g of 10% Fluorad FC-430, and 0.1 g of T-12.

### EXAMPLE 6

The procedure of example 1 was followed except that 10.10 g (0.0315 eq.) of Joncryl 500 acrylic instead of Macrynal and 61.66 g (0.3346 eq) of HD-100 were initially utilized. Subsequently, 32.70 g (0.1673 eq.) of HT-2000 were added. The resulting reaction mixture was heated for 3.5 hr. to yield a composition having the following properties: NCO/OH=15.93; % NCO (theoretical)=18.92; % NCO (experimental)=18.42%; viscosity=1,154 cP. Table 1 provides a summary of the properties of the prepolymer compositions formed by the method of the present invention. Surprisingly, the method of the present inventions produces prepolymer compositions with viscosities less than 2000 cP with values as low as 800 being attainable. These low values make the compositions particularly useful for forming coatings.

TABLE 1
Summary of properties for prepolymer composition

| | additional | | % | viscosity | | |
|---|---|---|---|---|---|---|
| Example | diisocyanate | polyol | solids | (cP) | % NCO | NCO/OH |
| 1 | HB-9000 | Macrynal | 95.3 | 1799 | 17.78 | 15.84 |
| | | VSM 2800 | | | | |
| 2 | HB-9000 | Joncryl 500 | 88.0 | 787.4 | 19.06 | 15.91 |
| 3 | HT-2000 | Acryflow | 98.8 | 1064 | 18.54 | 15.90 |
| | | P130 | | | | |
| 4 | HT-2000 | Acryflow | 100 | 1984 | 18.37 | 15.95 |
| | | P120 | | | | |
| 5 | HT-2000 | Macrynal | 95.3 | 1461 | 17.66 | 15.85 |
| | | VSM 2800 | | | | |
| 6 | HT-2000 | Joncryl 500 | 98.1 | 1154 | 18.92 | 15.93 |

Coatings Made With the Formulations of the Present Invention.

Tables 2 and 3 provide physical properties and chemical resistance for coatings made from the formulations set forth above. Formulations 1, 4, and 5 are used to coat polished 4 inch by 12 inch polished cold rolled steel test panels that have been treated with Bonderite™ 1000. The test panels are coated with enough material to produce a 2 to 4 mil thick dry coating. The coatings are allowed to flash for 2 hours and then allowed to cure at about 25° C. at 50% relative humidity for at least two weeks. Cross Hatch (“X-hatch) provides a measure of the ability of a coating to adhere to a surface. The Cross Hatch test is performed by making two perpendicular cuts on a coated sample with a Gardener crosshatch tool. Scotch™ tape is then applied to the crosshatched area and then removed. The crosshatched area is then examined for coating not removed by the tape and reported as the percent of coating removed. The direct and reverse impact tests are performed in accordance with ASTMD-2794. In such tests, the face of a coated panel is impacted with a weight then impacted at the same area from the other (reverse) side. This gives an indication of the flexibility of the coating under quick deformation. Pendulum hardness is determined in accordance with ASTM D-4366-87A .

TABLE 2
Chemical resistance of coatings made with
formulations of the present invention.

| Property | Formulation 1 | Formulation 4 | Formulation 5 |
|---|---|---|---|
| Thickness (mil) | 2.27 | 4.3 | 2.79 |
| gloss 20° | 96 | 91.3 | 98.5 |
| gloss 60° | 104 | 104.9 | 110.2 |
| X-hatch adhesion | 0 | 0 | 0 |
| (percent | | | |
| removed) | | | |
| direct impact (lb) | 160 | 160 | 160 |
| reverse impact | 160 | 160 | 160 |
| (lb) | | | |
| pendulum | 151 | 116 | 162 |
| hardness (swings) | | | |
| ⅛ inch bend | pass | pass | pass |

TABLE 3
Chemical resistance of coatings made
with formulations of the present invention.

| Chemical | Formulation 1 | Formulation 4 | Formulation 5 |
|---|---|---|---|
| methyl ethyl | ring | ring | ring |
| ketone (MEK) | | | |
| xylene | ring | ring | ring |
| 10% HCl | no effect | no effect | no effect |
| 10% NaOH | no effect | no effect | no effect |
| 10% acetic acid | no effect, slight | no effect, very | no effect, very |
| | marring | slight marring | slight marring |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A urethane prepolymer blend made by the method comprising:
providing HDI-uretidione and a polyol wherein the polyol has two or more hydroxyls; and
reacting the HDI-uretidione with the polyol to form a urethane prepolymer that is moisture-curable and has a viscosity at 25° C. less than about 3000 cps, the urethane prepolymer having less than about 1% by weight diisocyanate monomer wherein the HDI-uretidione and the polyol are is a sufficient amount that the reaction index is at least about 2.

2. The urethane prepolymer blend of claim 1 wherein the HDI-uretidione and the polyol are present in a sufficient amount that the reaction index is at least about 5.

3. The urethane prepolymer blend of claim 1 wherein the HDI-uretidione and the polyol are present in a sufficient amount that the reaction index is at least about 10.

4. The urethane prepolymer blend of claim 1 wherein the polyol is a polyether polyol, a polyester polyol, an acrylic polyol, or mixtures thereof.

5. The urethane prepolymer blend of claim 1 wherein the polyol is a hydroxy-functional acrylate resin which comprises recurring units of:
(a) a propoxylated allylic alcohol of the formula CH₂═CR—CH₂—(A)ₙ—OH in which A is an oxypropylene group, R is selected from the group consisting of hydrogen and C₁-C₅ alkyl, and n, which is the average number of oxypropylene groups in the propoxylated allylic alcohol, has a value less than or equal to 2;
(b) a C₁-C₂₀ alkyl or aryl acrylate or methacrylate monomer; and
(c) optionally, one or more ethylenic monomers selected from the group consisting of vinyl aromatic monomers, unsaturated nitrites, vinyl esters, vinyl ethers, vinyl halides, vinylidene halides, unsaturated anhydrides, unsaturated dicarboxylic acids, acrylic and methacrylic acids, acrylamide and methacrylamide, and conjugated dienes;
wherein the acrylate resin has a hydroxyl number within the range of about 20 to about 500 mg KOH/g, and a number average molecular weight within the range of about 500 to about 10,000.

6. The urethane prepolymer blend of claim 5 wherein acrylate resin has a hydroxyl number within the range of about 50 to about 450 mg KOH/g

7. The urethane prepolymer blend of claim 5 wherein the acrylate resin has a hydroxyl number within the range of about 20 to about 500 mg KOH/g, and a number average molecular weight within the range of about 500 to about 10,000.

8. The urethane prepolymer blend of claim 5 wherein the acrylate or methacrylate monomer is a C₁-C₁₀ alkyl acrylate or methacrylate.

9. The urethane prepolymer blend of claim 1 further comprising one or more components selected from the group consisting of aliphatic diisocyanate adducts, catalysts, cross-linking agents, chain lengthening agents, flow promoting agents, surfactants, UV stabilizers, fillers, pigments, solvents, and mixtures thereof.

10. The urethane prepolymer blend of claim 1 further comprising a component selected from the group consisting of an isocyanate trimer, and HDI biuret, HDI allophanates, or mixtures thereof.

11. The urethane prepolymer blend of claim 1 wherein the HDI-uretidione is reacted with the polyol by charging a reaction vessel with the HDI-uretidione and then slowly adding the polyol to the reaction vessel.

12. The urethane prepolymer blend of claim 1 wherein the HDI-uretidione is reacted with the polyol by mixing the HDI-uretidione and the polyol together in a reaction vessel.

13. A method for preparing a urethane prepolymer blend, the method comprising:
providing HDI-uretidione and a polyol, the polyol having two or more hydroxyls; and
reacting the HDI-uretidione with the polyol such that a urethane prepolymer that is moisture-curable and has a viscosity at 25° C. less than about 3000 cps is formed;
wherein the HDI-uretidione and the polyol are of sufficient amounts that the reaction index is from about 10 to about 20. More preferably, the reaction index in this embodiment is from about 12 to 17; and more preferably the reaction index is about 15.

14. The method of claim 13 wherein the HDI-uretidione and the polyol are of sufficient amounts that the reaction index is from about 12 to about 17.

15. The method of claim 13 wherein the HDI-uretidione and the polyol are is a sufficient amount that the reaction index is about 15.

16. The method of claim 13 wherein the polyol is a polyether polyol, a polyester polyol, an acrylic polyol, or mixtures thereof.

17. The method of claim 13 further comprising one or more components selected from the group consisting of aliphatic diisocyanate adducts, catalysts, cross-linking agents, chain lengthening agents, flow promoting agents, surfactants, UV stabilizers, fillers, pigments, solvents, and mixtures thereof.

18. The method of claim 13 further comprising a component selected from the group consisting of an isocyanate trimer, an HDI biuret, HDI allophanates, or mixtures thereof.

19. The method of claim 13 wherein the HDI-uretidione is reacted with the polyol by charging a reaction vessel with the HDI-uretidione and then slowly adding the polyol to the reaction vessel.

20. The method of claim 13 wherein the HDI-uretidione is reacted with the polyol by mixing the HDI-uretidione and the polyol together in a reaction vessel.

21. A method of coating a substrate with a urethane coating, the method comprising:
providing HDI-uretidione and a polyol wherein the polyol has two or more hydroxyls; and
reacting the HDI-uretidione with the polyol to form a urethane prepolymer that is moisture-curable and has a viscosity at 25° C. less than about 3000 cps, the urethane prepolymer having less than about 1% by weight diisocyanate monomer wherein the HDI-uretidione and the polyol are of sufficient amounts that the reaction index is at least about 2;
applying the urethane prepolymer to the substrate to form a coated substrate; and
curing the coated substrate.

22. The method of claim 21 wherein the step of curing the coated substrate is done by allowing the coated substrate to moisture cure in ambient air.

23. The method of claim 21 wherein the HDI-uretidione and the polyol are of sufficient amounts that the reaction index is at least about 5.

24. The method of claim 21 wherein the HDI-uretidione and the polyol are of sufficient amounts that the reaction index is at least about 10.

25. The method of claim 21 wherein the polyol is a polyether polyol, a polyester polyol, an acrylic polyol, or mixtures thereof.

26. The method of claim 21 wherein the polyol is a hydroxy-functional acrylate resin which comprises recurring units of:
(a) a propoxylated allylic alcohol of the formula CH₂═CR—CH₂—(A)ₙ—OH in which A is an oxypropylene group, R is selected from the group consisting of hydrogen and C₁-C₅ alkyl, and n, which is the average number of oxypropylene groups in the propoxylated allylic alcohol, has a value less than or equal to 2;
(b) a C₁-C₂₀ alkyl or aryl acrylate or methacrylate monomer; and
(c) optionally, one or more ethylenic monomers selected from the group consisting of vinyl aromatic monomers, unsaturated nitrites, vinyl esters, vinyl ethers, vinyl halides, vinylidene halides, unsaturated anhydrides, unsaturated dicarboxylic acids, acrylic and methacrylic acids, acrylamide and methacrylamide, and conjugated dienes;
wherein the acrylate resin has a hydroxyl number within the range of about 20 to about 500 mg KOH/g, and a number average molecular weight within the range of about 500 to about 10,000.

27. The urethane prepolymer blend of claim 26 wherein acrylate resin has a hydroxyl number within the range of about 50 to about 450 mg KOH/g

28. The urethane prepolymer blend of claim 26 wherein the acrylate resin has a hydroxyl number within the range of about 20 to about 500 mg KOH/g, and a number average molecular weight within the range of about 500 to about 10,000.

29. The urethane prepolymer blend of claim 26 wherein the acrylate or methacrylate monomer is a C₁-C₁₀ alkyl acrylate or methacrylate.

30. The method of claim 21 further comprising one or more components selected from the group consisting of aliphatic diisocyanate adducts, catalysts, cross-linking agents, chain lengthening agents, flow promoting agents, surfactants, UV stabilizers, fillers, pigments, solvents, and mixtures thereof.

31. The method of claim 21 further comprising a component selected from the group consisting of an isocyanate trimer, an HDI biuret, HDI allophanates, or mixtures thereof.
